(19) United States
(12) Patent Application Publication
(10) Pub. No.: US 2003/0133585 A1
(43) Pub. Date: Jul. 17, 2003

(54) Hands-free kit for mobile phone

(76) Inventor: Wah Hing Cheung, Hong Kong (HK)

Correspondence Address: David P. Gordon, Esq., 65 Woods End Road, Stamford, CT, 06905, US

(21) Appl. No.: 10/046,838

(22) Filed: Jan. 15, 2002

(51) Int. Cl. H04R 25/00

(52) U.S. Cl. 381/382; 381/370; 381/380

(57) ABSTRACT

A hands-free kit for a mobile phone includes an acoustic passage for use with a mobile phone hands-free earphone provided with a speaker and a microphone. The passage comprises a flexible tube having a first end with a mechanism that connects with the speaker and a second end including an earplug. The tube transmits sound reproduced by the speaker to the earplug. The mechanism has a box providing a cavity which houses and locates wholly therein the speaker and includes an opening to which the first end of the tube is connected for communicating with the cavity. The box and the tube are made of a material that does not transmit electromagnetic radiation of the mobile phone as transmitted or emitted by the speaker.

The present invention relates to a hands-free kit for use with a mobile phone.

### BACKGROUND OF THE INVENTION

Hands-free kits, each including an earphone and a microphone, are becoming popular for use with portable mobile phones, as they free the hands of a user who can then attend to other things as desired or with care, such as driving a vehicle. Experiments or statistics suggest that the electromagnetic radiation emitted by a mobile phone may be harmful to the brain. Although a hands-free kit is useful to keep the mobile phone physically away from the head, electrically conductive parts of the kit, including in particular the earphone that is in use located in the ear, also transmit and emit electromagnetic radiation.

The invention seeks to mitigate or to at least alleviate such a problem by providing a hands-free kit for a mobile phone.

### SUMMARY OF THE INVENTION

According to a first aspect of the invention, there is provided a hands-free kit for a mobile phone having a hands-free connection port, comprising a speaker, a microphone, a connector for connection with a said port, an electrical cable connecting the speaker and the microphone to the connector, and a tube having a first end connectable with the speaker and a second end comprising an earplug. The tube is adapted to act as an acoustic passage to transmit sound reproduced by the speaker to the earplug.

Preferably, the tube is flexible, and may be made of non-metallic material, such as rubber or plastic material.

It is preferred that the speaker has a body, and the first end of the tube receives to enclose and thus connect with the speaker body.

It is further preferred that the tube is enlarged at its first end to connect with the speaker body, and includes a section immediately adjacent the enlarged end that is tapered to concentrate sound emitted by the speaker into the tube.

According to a second aspect of the invention, there is provided an acoustic passage for use with a mobile phone hands-free earphone comprising a speaker and a microphone, which passage comprises a tube having a first end comprising means for connecting with a said speaker and a second end comprising an earplug. The tube is adapted to transmit sound reproduced by the speaker to the earplug.

Preferably, the tube is flexible, and may be made of non-metallic material, such as rubber or plastic material.

It is preferred that the first end of the tube is adapted to receive and thus connect with a said speaker.

It is further preferred that the first end of the tube is enlarged for connecting with a said speaker, and the tube includes a section immediately adjacent the enlarged end that is tapered to concentrate sound emitted by a said speaker into the tube.

In a preferred embodiment, said means comprises an enclosure which provides a cavity adapted to house and locate wholly therein a said speaker and includes an opening to which the first end of the tube is connected for communicating with the cavity.

Preferably, the cavity has an entire inner surface and is provided with a metal shield that covers a substantial part of the entire inner surface to surround a said speaker.

More preferably, the shield is formed by two substantially identical shells closing with each other.

It is preferred that the shield has a shape matching with that of the inner surface of the cavity and is in ultimate surface contact therewith.

Preferably, the enclosure provides a first cavity that is the first mentioned cavity and also a second cavity that provides a sound passage which has a first end connected to the first cavity for communicating therewith and a second end that acts as the opening to which the first end of the tube is connected.

More preferably, the sound passage extends in a substantially spiral manner having an outer end as the said first end and an inner end as the said second end.

Further more preferably, the sound passage has at least half a turn and up to two turns.

Preferably, the enclosure provides another cavity adapted to house and locate wholly therein a said microphone.

More preferably, said another cavity has an entire inner surface and is provided with a metal shield that covers substantially the entire inner surface to surround a said microphone.

Further, the shield is preferably formed by two substantially identical shells closing with each other.

It is preferred that the shield has a shape matching with that of the inner surface of the cavity and is in ultimate surface contact therewith.

In a specific construction, the enclosure is to be formed by two connected parts having respective walls abutting each other, which walls are shaped and combine to form at their interface the cavity or cavities.

More specifically, the or each cavity is formed by two substantially identical parts, one from the wall of each part of the enclosure.

Conveniently, the enclosure has an open outer side and a hollow interior accessible through the open side for storing at least part of the tube and the earplug.

Conveniently, the enclosure is provided with a fastener for fastening the overall acoustic passage onto the body of a user.

In a specific construction, the earplug comprises a tubular plug for insertion into the hole of a user's ear and an integral outer member extending around the plug for holding onto the inner surface of a said user's ear by friction.

The acoustic passage may be combined with a mobile phone hands-free earphone comprising a speaker and a microphone, in which the speaker is housed within the or the first cavity.

The acoustic passage may be combined with a mobile phone hands-free earphone comprising a speaker and a microphone, in which the speaker is housed within the or the first cavity and the microphone is housed within said another cavity.

### BRIEF DESCRIPTION OF DRAWINGS

The invention will now be more particularly described, by way of example only, with reference to the accompanying drawings, in which:

FIG. 1 is a cross-sectional view of a first embodiment of a hands-free kit in accordance with the invention, showing its use with a mobile phone;

FIG. 2 is a side view of a conventional hands-free earphone;

FIG. 3 is a cross-sectional side view of a second embodiment of a hands-free kit in accordance with the invention, said kit incorporating the hands-free earphone of FIG. 2;

FIG. 4 is a top plan view of the hands-free kit of FIG. 3;

FIG. 5 is a bottom plan view of the hands-free kit of FIG. 3;

FIG. 6 is a top plan view of the hands-free kit of FIG. 3, showing the kit in a packed condition;

FIG. 7 is a cross-sectional end view of the packed hands-free kit of FIG. 6;

FIG. 8 is a bottom plan view of a slightly different embodiment of the hands-free kit of FIG. 3; and

FIG. 9 is a side view of a modified earplug for the hands-free kit of FIG. 3 or FIG. 8.

### DETAILED DESCRIPTION OF PREFERRED EMBODIMENTS

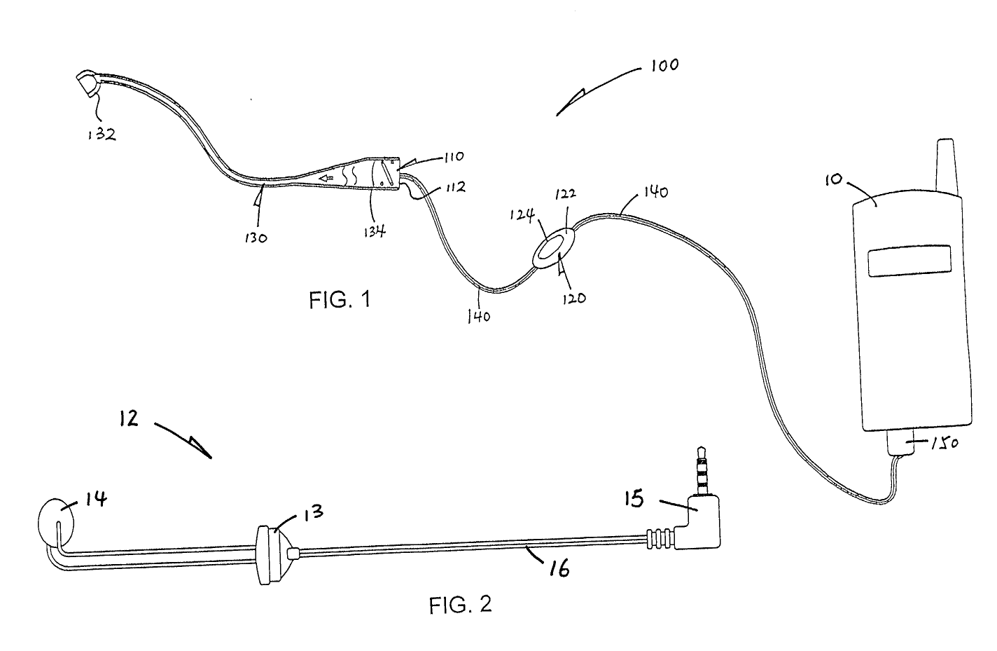

Referring initially to FIG. 1 of the drawings, there is shown a first hands-free kit 100 embodying the invention for use with a portable mobile phone 10, which kit 100 comprises a macro speaker 110, a microphone 120 and a flexible rubber tube 130. The speaker 110 is connected to the microphone 120 by means of a multi-cored cable 140 that extends beyond the microphone 120. The cable 140 terminates at an end fitted with a signal plug 150 designed for insertion into a hands-free connection port provided at the bottom end of the mobile phone 10.

The speaker 110 has a body 112 and includes a sound reproducing mechanism, such as a diaphragm driven by a moving coil and electromagnet, for reproducing sound from an electrical signal supplied by the mobile phone 10 via the cable 140. The microphone 120 has an oval-shaped body 122 which is connected at an intermediate position along the cable 140 and includes a press knob 124 for accepting or terminating a telephone call.

The tube 130 has a front end provided with an earplug 132 and a rear end that is suitably enlarged to form a receptacle 134, for example, for receiving to enclose and thus connect with the speaker 110. The main body of the tube 130 acts as an acoustic passage for transmitting or delivering sound from the speaker 110 to the earplug 132, and is made generally as thin as possible for flexibility and lightweight.

The earplug 132 has a front opening and is preferably integrally formed at the front end of the tube 130, or otherwise formed as a separate part connected thereto. The earplug 132 is shaped and sized to anchor within the user's ear.

The receptacle 134 has a shape corresponding to that of the body 112 of the speaker 110 and is preferably slightly stretchable for enclosing the speaker body 112 to connect tight therewith. The section of the tube 130 immediately adjacent the receptacle 134 is preferably made to taper in a conical manner, gradually reducing in diameter from the receptacle 134, for concentrating and directing the sound emitted by the speaker 110 into the tube 130.

The rubber tube 130 serves to separate the speaker 110 apart from the user's ear as far as possible for a distance that is in effect the length of the tube 130, thereby isolating or at least substantially minimising the effect of the electromagnetic radiation of the mobile phone 10 as transmitted or emitted by the speaker 110. The tube 130 acts as a voice collector bridging from the speaker 110 to the user's ear, said connector containing no metallic or electrically conductive material to transmit electromagnetic radiation.

In general, the tube 130 is made of non-metallic material. Specifically, the tube 130 is preferably made of rubber, silicone rubber or other suitable plastic material. It is known that certain material can suppress or absorb electromagnetic radiation, and such material is also suitable for producing the tube 130, as either the base material or an additive.

In the described hands-free kit 100, the tube 130 is about 20 cm long, and the microphone 120 is connected on the cable 140. In a different construction, it is envisaged that the microphone 120 may be mounted on the tube 130 instead, at around the rear end of the tube 130, such that the microphone 120 is positioned closer to the user's mouth.

Apart from the tube 130, the other parts of the hands-free kit 100 may be standard components of a conventional hands-free earphone, with the speaker 110 being in the form of a typical earphone. It is therefore intended that the tube 130 may be supplied alone as an accessory for use with an existing hands-free earphone, in which case the rear end of the tube 130 should be fabricated for (releasable) connection to the earphone.

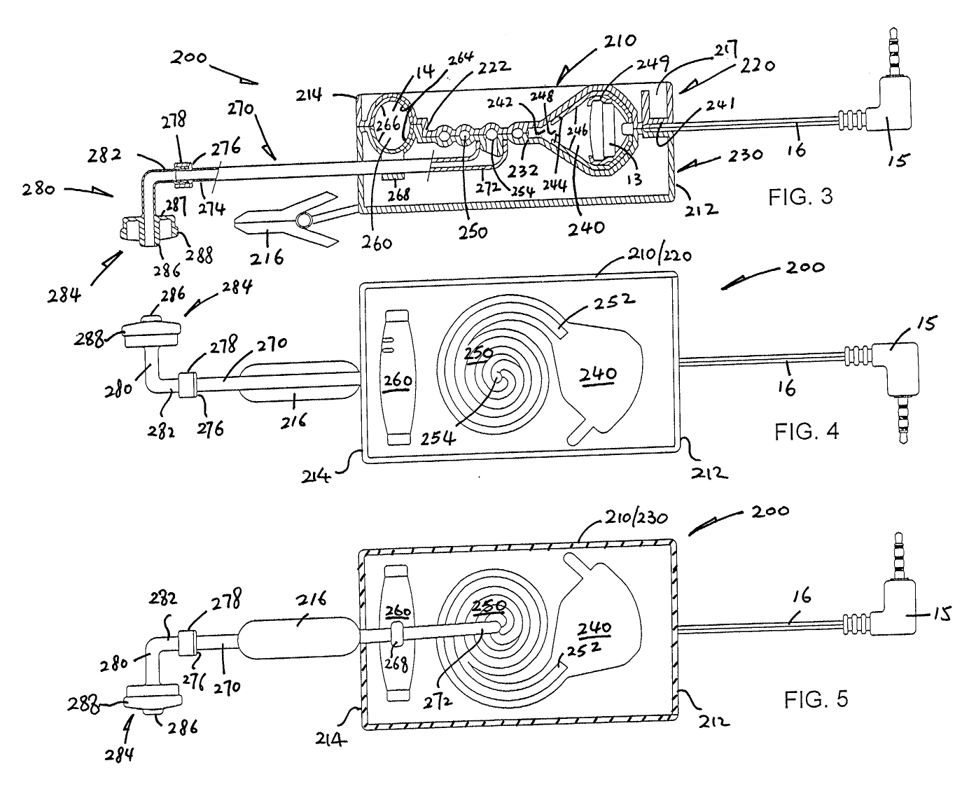

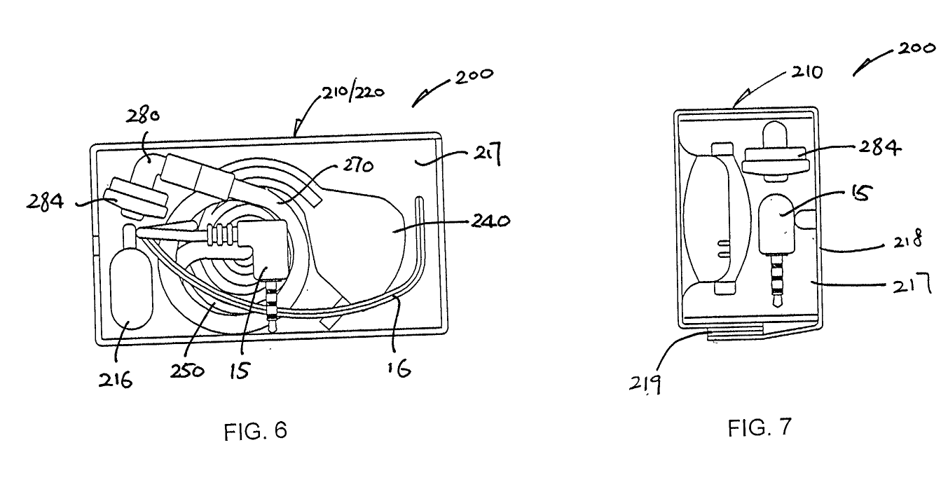

Reference is now made to FIGS. 2 to 7 of the drawings, which show a second hands-free kit 200 embodying the invention for use with a portable mobile phone. The kit 200 incorporates a conventional hands-free earphone 12 that comprises a macro speaker 13 and a microphone 14 and includes a signal plug 15 to which both the speaker 13 and the microphone 14 are connected by means of a multi-cored cable 16. The plug 15 is designed for insertion into a hands-free connection port of a mobile phone.

The hands-free kit 200 includes an enclosure in the form of a rectangular (or round) plastic box 210 having opposite first and second ends 212 and 214, which is formed by top and bottom parts 220 and 230 that have matching rectangular (or round) shapes and are stacked and secured together by ultrasonic welding. The top and bottom box parts 220 and 230 have respective lower and upper walls 222 and 232 abutting each other, which are both moulded to form in their interfacing surfaces a series of three enclosed cavities 240, 250 and 260 along the longitudinal extent of the box 210. An external fastener in the form of a spring-loaded clip 216 is provided at the second end 214 of the box 210.

Each cavity 240/250/260 is created by a corresponding pair of aligned recesses closing with each other, which have substantially identical shapes as mirror images compared with each other and are formed in the confronting walls 222 and 232 of the two box parts 220 and 230 respectively. The first and second cavities 240 and 250 are in communication with each other.

The first cavity 240 is generally pear-shaped having a conically tapered open front end 242 and houses wholly therein the speaker 13 of the hands-free earphone 12. A metal (copper, aluminium or iron) shield 244 of a matching shape is located within the cavity 240 to cover, in ultimate surface contact with, a substantial part of the entire inner surface of the cavity 240. The shield 244 surrounds the speaker 13 and is intended to confine the electromagnetic radiation of the speaker 13 within the cavity 240 and thus avoid or minimise its leakage out of the cavity 240. The shield 244 is formed by a pair of identical upper and lower shells 246 closing with each other, together having a conically tapered open front end 248 aligned with the open end 242 of the cavity 240.

The speaker 13 is preferably surrounded tight by a ring 249 of a soft material such as rubber and is then clamped between the two shells 246 of the shield 244. The ring 249 serves to ensure that the speaker 13 is fixed and is better acoustically shielded. The speaker 13 is located to be directly facing and pointing at the aligned open ends 248 and 242 of the shield 240 and cavity 240, such that the sound reproduced by the speaker 13 is concentrated and guided by the conically tapered open ends 248 and 242 into the second cavity 250.

A passage 241 is formed at the interface between the confronting walls 222 and 232 of the two box parts 220 and 230, which extends from rear ends of the first cavity 240 and shield 244 to the outside at the first end 212 of the box 210. The passage 241 accommodates and allows the section of the cable 16 of the hands-free earphone 12 connecting between the speaker 13 and the signal plug 15 to extend out of the box 210, such that the signal plug 15 stays outside the box 210.

The second cavity 250 extends in a spiral manner or shape of at least half a turn and up to two turns, having outer and inner open ends 252 and 254. The outer end 252 is integrally formed with the open end 242 of the first cavity 240. The first cavity 240 is oriented at an acute angle of about 45° relative to the second cavity 250 such that their open ends 242 and 248 are co-axially aligned with each other. This arrangement ensures that the sound of the speaker 13 from the first cavity 240 can enter straight, without turning, into the second cavity 250, whereby loss of sound is minimised.

The second cavity 250 provides a smoothly curved, spiral sound passage for delivering the sound received from the first cavity 240. The inner end 254 of the second cavity 250 turns through an angle of 90° to point downwards off the plane of the spiral shape.

The third cavity 260 has an oblong shape that extends laterally across the box 210 and corresponds to that of the microphone 14 of the hands-free earphone 12 for housing the entire microphone 14. A metal (copper or aluminium) shield 264 of a matching shape is located within the cavity 260 to cover, in ultimate surface contact with, substantially the entire inner surface of the cavity 260. The shield 264 is formed by a pair of identical upper and lower shells 266 closing with each other to surround the microphone 14, and serves to confine electromagnetic radiation of the microphone 14 within the cavity 260 and thus avoid or minimise its leakage out of the cavity 260.

Although this is not shown in the drawings, another passage is formed at the interface between the confronting walls 222 and 232 of the two box parts 220 and 230, which extends between the first and the third cavities 240 and 260 and accommodates the section of the cable 16 connecting between the speaker 13 and microphone 14.

The hands-free kit 200 further includes a flexible acoustic tube 270/280 that is formed by a relatively long rubber tube 270 and a relative short soft plastic pipe 280 connected lengthwise together. The rubber tube 270 has a crooked first end 272 placed inside the lower part 230 of the box 210, which is stretched over to connect with the inner end 254 of the second cavity 250, for communicating with the cavity 250. An integral hook or bracket 268 extends from below the third cavity 260 and holds the tube 270 in place. The tube 270 extends out from the second end 214 of the box 210 and then terminates as a straight second end 274 formed with an annular integral flange 276.

The pipe 280 is crooked, having a first end 282 coupled straight with the second end 274 of the rubber tube 270 by means of a rigid locking collar 278, and including a second end in the form of an earplug 284. The collar 278 is slid on and locks the pipe end 282 tightly around the tube end 274 at a position stopped by the flange 276.

The earplug 284 has a central tubular plug 286 and a generally flat cylindrical outer flange 288 extending concentrically around the plug 286. The flange 288 is spaced apart from the plug 286 and is integrally connected to the rear end of the plug 286 by a circular disc-like web 287. The flange 288 and the web 287 together resemble a cap, with the plug 286 protruding slightly out of the cap or beyond the flange 288. When the earplug 284 is inserted into the ear of a user, the plug 286 extends into the hole of the ear for sound delivery, while the flange 288 holds onto the inner surface of the ear by friction and thus locates the overall earplug 284 in place.

The top part 220 of the box 210 is hollow around the regions forming the upper halves of the cavities 240 to 260, and its outer (upper) side 217 is open into which the hollow interior is accessible. The interior is useful to store the acoustic tube 270/280 over the majority of its exposed length and the signal plug 15 with cable 16 running therefrom, when the hands-free kit 200 is not in use. Appropriate top cut-outs may be formed in the side walls of the box part 220 to facilitate entrance of the acoustic tube 270/280 and the signal plug cable 16 into the storage space. The open side 217 is to be closed by a flap 218 extending from a longer side of the box 210 to the opposite side where suitable Velcro (trade mark) connectors 219 are provided.

The box 210 measures approximately 8.5 cm by 5.6 cm, and the exposed length of the acoustic tube 270/280 is preferably in the range from 16.5 cm to 28 cm.

In use, the hands-free kit 200 is hanged on the chest of a user by means of the clip 216, with the signal plug 15 connected to a mobile phone and the earplug 284 inserted into either the left or the right ear of the user. The acoustic tube 270/280, which is joined to the second cavity 250, acts as an acoustic passage for delivering the sound of the speaker 13 received from the first cavity 240 via the second cavity 250. The sound travels on to reach the user's ear via the earplug 284.

The acoustic tube 270/280 serves to separate the speaker 13 physically apart from the user's ear, and hence the brain, for a distance that is believed to be sufficiently long to isolate or at least substantially minimise the undesirable effect of the electromagnetic radiation of a mobile phone in use as transmitted or emitted by the speaker 13. The tube 270/280 does not contain any metallic or electrically conductive material that transmits electromagnetic radiation. The tube 270/280 is preferably made of (silicone) rubber and/or plastic material or any other suitable non-metallic material. Certain material known to suppress or absorb electromagnetic radiation may also be used, as either the base material or an additive.

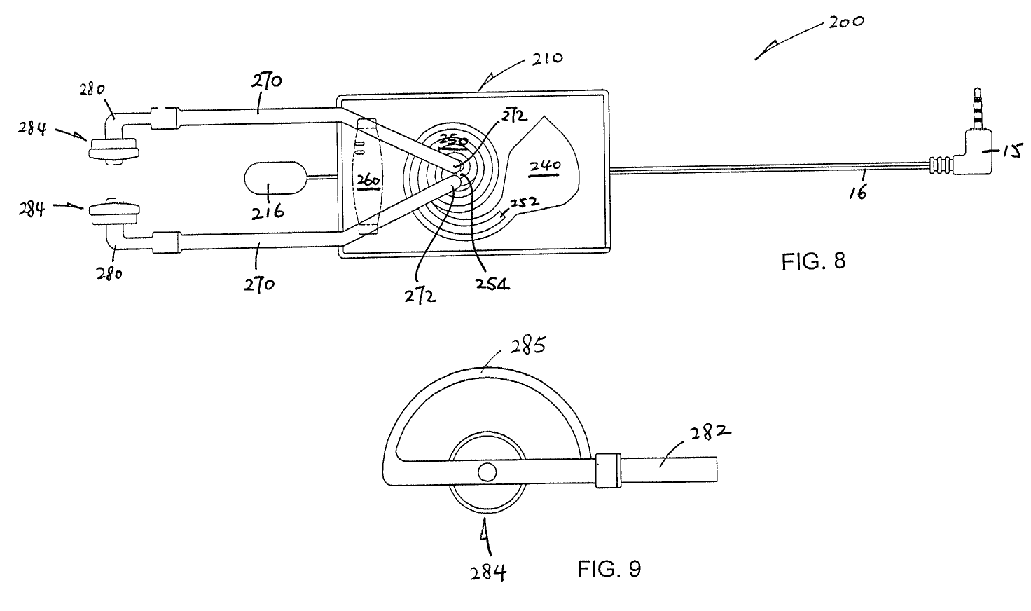

As shown in FIG. 8, the hands-free kit 200 may incorporate a pair of the acoustic tubes 270/280, in which case the ends 272 of both tubes 270 are connected to the inner end 254 of the second cavity 250 for simultaneous communication with the cavity 250. The pair of earplugs 284 can be used in both the left and right ears of a user.

As shown in FIG. 9, the earplug 284 may incorporate a semi-circular bracket 285 for hooking onto the user's ear.

It is intended that the hands-free kit 200 may be supplied to the market without the hands-free earphone 12, such that customers may use their own hands-free earphones of the same or similar construction having compatible dimensions. For this purpose, the two parts 220 and 230 of the box 210 should not be welded or glued together in the first place but instead should be openable to allow insertion of a suitable hands-free earphone.

The invention has been given by way of example only, and various other modifications of and/or alterations to the described embodiments may be made by persons skilled in the art without departing from the scope of the invention as specified in the appended claims.

What is claimed is:

1. A hands-free kit for a mobile phone having a hands-free connection port, comprising a speaker, a microphone, a connector for connection with a said port, an electrical cable connecting the speaker and the microphone to the connector, and a tube having a first end connectable with the speaker and a second end comprising an earplug, said tube being adapted to act as an acoustic passage to transmit sound reproduced by the speaker to the earplug.

2. The hands-free kit as claimed in claim 1, wherein the tube is flexible.

3. The hands-free kit as claimed in claim 1, wherein the tube is made of non-metallic material.

4. The hands-free kit as claimed in claim 1, wherein the tube is made of rubber material.

5. The hands-free kit as claimed in claim 1, wherein the tube is made of plastic material.

6. The hands-free kit as claimed in claim 1, wherein the speaker has a body, and the first end of the tube receives to enclose and thus connect with the speaker body.

7. The hands-free kit as claimed in claim 6, wherein the tube is enlarged at its first end to connect with the speaker body, and includes a section immediately adjacent the enlarged end that is tapered to concentrate sound emitted by the speaker into the tube.

8. An acoustic passage for use with a mobile phone hands-free earphone comprising a speaker and a microphone, which passage comprises a tube having a first end comprising means for connecting with a said speaker and a second end comprising an earplug, said tube being adapted to transmit sound reproduced by the speaker to the earplug.

9. The acoustic passage as claimed in claim 8, wherein the tube is flexible.

10. The acoustic passage as claimed in claim 8, wherein the tube is made of non-metallic material.

11. The acoustic passage as claimed in claim 8, wherein the tube is made of rubber material.

12. The acoustic passage as claimed in claim 8, wherein the tube is made of plastic material.

13. The acoustic passage as claimed in claim 8, wherein the first end of the tube is adapted to receive and thus connect with a said speaker.

14. The acoustic passage as claimed in claim 13, wherein the first end of the tube is enlarged for connecting with a said speaker, and the tube includes a section immediately adjacent the enlarged end that is tapered to concentrate sound emitted by a said speaker into the tube.

15. The acoustic passage as claimed in claim 8, wherein said means comprises an enclosure which provides a cavity adapted to house and locate wholly therein a said speaker and includes an opening to which the first end of the tube is connected for communicating with the cavity.

16. The acoustic passage as claimed in claim 15, wherein the cavity has an entire inner surface and is provided with a metal shield that covers a substantial part of the entire inner surface to surround a said speaker.

17. The acoustic passage as claimed in claim 16, wherein the shield is formed by two substantially identical shells closing with each other.

18. The acoustic passage as claimed in claim 16, wherein the shield has a shape matching with that of the inner surface of the cavity and is in ultimate surface contact therewith.

19. The acoustic passage as claimed in claim 15, wherein the enclosure provides a first cavity that is the first mentioned cavity and also a second cavity that provides a sound passage which has a first end connected to the first cavity for communicating therewith and a second end that acts as the opening to which the first end of the tube is connected.

20. The acoustic passage as claimed in claim 19, wherein the sound passage extends in a substantially spiral manner having an outer end as the said first end and an inner end as the said second end.

21. The acoustic passage as claimed in claim 20, wherein the sound passage has at least half a turn and up to two turns.

22. The acoustic passage as claimed in claim 15, wherein the enclosure provides another cavity adapted to house and locate wholly therein a said microphone.

23. The acoustic passage as claimed in claim 22, wherein said another cavity has an entire inner surface and is provided with a metal shield that covers substantially the entire inner surface to surround a said microphone.

24. The acoustic passage as claimed in claim 23, wherein the shield is formed by two substantially identical shells closing with each other.

25. The acoustic passage as claimed in claim 23, wherein the shield has a shape matching with that of the inner surface of the cavity and is in ultimate surface contact therewith.

26. The acoustic passage as claimed in claim 15, wherein the enclosure is to be formed by two connected parts having respective walls abutting each other, which walls are shaped and combine to form at their interface the cavity or cavities.

27. The acoustic passage as claimed in claim 26, wherein the or each cavity is formed by two substantially identical parts, one from the wall of each part of the enclosure.

28. The acoustic passage as claimed in claim 15, wherein the enclosure has an open outer side and a hollow interior accessible through the open side for storing at least part of the tube and the earplug.

29. The acoustic passage as claimed in claim 15, wherein the enclosure is provided with a fastener for fastening the overall acoustic passage onto the body of a user.

30. The acoustic passage as claimed in claim 15, wherein the earplug comprises a tubular plug for insertion into the hole of a user's ear and an integral outer member extending around the plug for holding onto the inner surface of a said user's ear by friction.

31. The acoustic passage as claimed in claim 15, in combination with a mobile phone hands-free earphone comprising a speaker and a microphone, wherein the speaker is housed within the or the first cavity.

32. The acoustic passage as claimed in claim 22, in combination with a mobile phone hands-free earphone comprising a speaker and a microphone, wherein the speaker is housed within the or the first cavity and the microphone is housed
